(19) United States
(12) Patent Application Publication
(10) Pub. No.: US 2007/0017288 A1
(43) Pub. Date: Jan. 25, 2007

(54) Piezoelectric vibration gyro sensor and electronic device equipped with the same

(76) Inventor: Kenji Sato, Matsumoto-shi (JP)

Correspondence Address: ANDERSON KILL & OLICK P.C., 1251 Avenue of the Americas, New York, NY, 10020, US

(21) Appl. No.: 11/490,360

(22) Filed: Jul. 20, 2006

(30) Foreign Application Priority Data
Jul. 20, 2005 (JP) 2005-209547

(51) Int. Cl. G01P 15/08

(52) U.S. Cl. 73/504.12

(57) ABSTRACT

A piezoelectric vibration gyro sensor includes: a) a piezoelectric vibration gyro element including: a central supporting portion having a plurality of electrode terminals provided thereon; a detection arm extending from two opposing sides of the central supporting portion and on a symmetry axis that passes through a center of the central supporting portion; a pair of connection arms extending from other opposing sides of the central supporting portion and in a direction orthogonal to the detection arm; and a pair of drive arms each extending from a tip of one of the pair of connection arms orthogonally to the respective connection arm and to both sides so that the pair of drive arms are symmetrically arranged with respect to the symmetry axis, wherein the central supporting portion, the detection arm, the pair of connection arms, and the pair of drive arms lie in a common plane; and b) a supporting substrate having a plurality of electrode leads one end of each of which is connected to a corresponding one of the plurality of electrode terminals to support the piezoelectric vibration gyro element, wherein the plurality of electrode terminals are disposed on a virtual circle whose center is a center of gravity of the piezoelectric vibration gyro element so as to be symmetrical with respect to the center of gravity, and wherein the plurality of electrode leads are each extended on an extension line that passes from the center of gravity through a central point of a corresponding one of the plurality of electrode terminals.

### BACKGROUND

1. Technical Field

The present invention relates to a piezoelectric vibration gyro sensor including a piezoelectric vibration gyro element to be transversely disposed, and to an electronic device including the piezoelectric vibration gyro sensor.

2. Related Art

In recent years, as vehicle body control and car navigation systems for vehicles, digital cameras, and digital video cameras are becoming increasingly sophisticated in functionality, there is an increasing demand for improvement of a position control function and a vibration control compensation function of such electronic devices as well as for miniaturization thereof. In such a situation, a piezoelectric vibration gyro sensor (hereinafter referred to as a “gyro sensor”) that includes a so-called transversely-disposed piezoelectric vibration gyro element (hereinafter referred to as a “gyro vibration piece”) is attracting attention. Using the gyro vibration piece made of piezoelectric monocrystal such as quartz, the gyro sensor detects as an angular velocity an electric signal that is generated at a part of the gyro vibration piece as a result of a vibration or rotation of a body in which the gyro sensor is mounted, and then, by calculating a rotation angle, the gyro sensor determines a vibration compensation amount for the aforementioned body. The gyro sensor is effective for making electronic devices more sophisticated in functionality and, since the transversely-disposed gyro vibration piece has a plane structure, has an advantage in making the electronic devices containing the gyro sensor miniaturized and slimmed down.

As a method for forming a structure of such a gyro sensor including the gyro vibration piece, there has been proposed a method of: preparing a supporting substrate made of insulative resin and having an opening formed at an inner portion thereof; forming a plurality of lead wires (hereinafter referred to as “electrode leads”) such that one end of each of the electrode leads is supported by the supporting substrate, the other end of each of the electrode leads is extended toward the center of the opening so as to achieve aerial wiring, and the gyro vibration piece and the supporting substrate is not in contact with each other; and connecting the other end of each of the electrode leads to a supporting portion (i.e., a supporting plate) of the gyro vibration piece. That is, the electrode leads, one end of each of which is connected to the supporting portion of the gyro vibration piece, serve to minimize influence of the supporting structure on a vibration characteristic of the gyro element by supporting the gyro element flexibly and in an elevated state from the same direction as a vibration direction of the gyro vibration piece as well as from a direction perpendicular to the vibration direction of the gyro vibration piece. In addition, the stiffness of at least either electrode leads that extend in the same direction as the vibration direction of the gyro vibration piece or electrode leads that extend in the direction perpendicular to the vibration direction of the gyro vibration piece is set to be lower than the stiffness of the electrode leads that supports the gyro vibration piece from the other directions. In this manner, the electrode leads having the higher stiffness serve to maintain reliability such as shock resistance or the like, while at the same time the electrode leads having the lower stiffness serve to avoid constraint or obstruction from occurring in connection with the vibration of the gyro vibration piece (see JP-A-2004-354169). Note that the piezoelectric vibration gyro sensor is normally disposed securely inside a case sealed by a cover plate to be protected from external force. In other words, a package structure is normally adopted therefor.

JP-A-2004-354169 is an example of related art.

However, the supporting structure of the gyro sensor as disclosed in the related art example involves problems as described below. When a strong shock is applied to the gyro sensor, a stress is imposed on the electrode leads having the lower stiffness so that bending occurs, which may cause the gyro vibration piece to be tilted in that direction. In the case where there is a slight displacement of any of the positions at which the electrode leads are connected to the supporting portion of the gyro vibration piece, the tilting of the gyro vibration piece is more likely to occur. If the tilting of the gyro vibration piece occurs in such a manner, a vibration detection axis of the gyro vibration piece is caused to shift, which leads to variations and changes in detection sensitivity of the gyro sensor. If a much stronger shock is applied to the gyro sensor, the gyro vibration piece may collide against an inner wall of the package case, resulting in breakage.

### SUMMARY

An advantage of the present invention is to provide a supporting structure of a piezoelectric vibration gyro element, a gyro sensor, and an electronic device equipped with the same, which achieve a flexible supporting structure that does not affect the vibration characteristic of the piezoelectric vibration gyro element and at the same time controls a tilting and displacement of the gyro vibration piece, which might be caused, for example, by a shock such as a falling, or a displacement in position of connection portions between the gyro vibration piece and a supporting substrate, while at the same time stable angular velocity detection performance and shock resistance are achieved.

According to an aspect of the invention, a piezoelectric vibration gyro sensor includes: a) a piezoelectric vibration gyro element including: a central supporting portion having a plurality of electrode terminals provided thereon; a detection arm extending from two opposing sides of the central supporting portion and on a symmetry axis that passes through a center of the central supporting portion; a pair of connection arms extending from other opposing sides of the central supporting portion and in a direction orthogonal to the detection arm; and a pair of drive arms each extending from a tip of one of the pair of connection arms orthogonally to the respective connection arm and to both sides so that the pair of drive arms are symmetrically arranged with respect to the symmetry axis, wherein the central supporting portion, the detection arm, the pair of connection arms, and the pair of drive arms lie in a common plane; and b) a supporting substrate having a plurality of electrode leads one end of each of which is connected to a corresponding one of the plurality of electrode terminals to support the piezoelectric vibration gyro element, wherein the plurality of electrode terminals are disposed on a virtual circle whose center is a center of gravity of the piezoelectric vibration gyro element so as to be symmetrical with respect to the center of gravity, and wherein the plurality of electrode leads are each extended on an extension line that passes from the center of gravity through a central point of a corresponding one of the plurality of electrode terminals.

According to this structure, the plurality of electrode terminals that function as supporting points for the gyro vibration piece are disposed on a virtual circle whose center is the center of gravity of the gyro vibration piece so as to be symmetrical with respect to the center of gravity. In other words, the electrode terminals are disposed so as to have relative positions such that the gyro vibration piece is supported evenly with respect to the center of gravity. One end of each of the electrode leads is connected to a corresponding one of the electrode terminals, and the other end thereof is extended in the direction of the extension line that passes from the center of gravity through the corresponding electrode terminal. That is, the relative positions of the plurality of electrode leads that are extended with one end connected to the corresponding electrode terminals to support the gyro vibration piece are arranged to be symmetrical with respect to the center of gravity. Therefore, a supporting structure is achieved that supports the gyro vibration piece evenly with respect to the center of gravity. Thus, the gyro vibration piece is supported in a well-balanced manner, whereby a stable vibration characteristic of the gyro vibration piece is achieved. When a shock such as a falling is applied, displacement of the gyro vibration piece is attenuated substantially evenly by the plurality of electrode leads. Therefore, troubles such as deterioration in detection sensitivity of the gyro vibration piece can be prevented, which might occur as a result of tilting of the gyro vibration piece caused by plastic deformation of one or more of the electrode leads. Thus, it is possible to provide a gyro sensor that has an excellent vibration detection characteristic and an excellent shock resistance.

It is preferable that the plurality of electrode leads be extended so as to be symmetrical, when viewed in plan, with respect to the symmetry axis or a virtual line that is orthogonal to the symmetry axis and passes through the center of gravity.

The detection arm and a pair of drive arms of the gyro vibration piece are arranged to experience bending vibration in circumferential directions, with the virtual line that is orthogonal to the symmetry axis of the gyro vibration piece and passes through the center of gravity as a central axis that functions as base points of vibration. Since at least a pair of electrode leads support the gyro vibration piece on the symmetry axis or an extension line of the central axis while the other electrode leads are arranged symmetrically with respect to the center of gravity to support the gyro vibration piece, the gyro vibration piece can be supported substantially evenly with respect to a vibration direction of each portion thereof. According to this structure, influence of the gyro vibration piece on vibration detection can be controlled, further preventing deterioration in detection sensitivity.

It is preferable that each of the plurality of electrode leads have an identical resonance frequency at least at a portion thereof that serves to support the piezoelectric vibration gyro element.

A portion of an electrode lead that serves to support the gyro vibration piece corresponds to a portion extending from a portion at which connection is achieved with the corresponding electrode terminal to a portion that is supported by the supporting substrate. Since the portion of each electrode lead that serves to support the gyro vibration piece has an identical resonance frequency, the gyro vibration piece can be supported more evenly with respect to the center of gravity of the gyro vibration piece by the plurality of electrode leads each having an identical spring characteristic. In addition, since the electrode leads connected to the electrode terminals have substantially identical electrical properties, such as impedance or the like, which contributes to stable transfer of electricity between the electrode leads and any part of the gyro vibration piece, a high detection sensitivity of the gyro sensor can be maintained.

It is preferable that the plurality of electrode leads be extended such that angles formed at the center of gravity by each pair of neighboring extension lines that pass from the center of gravity through the central points of the plurality of electrode terminals, on which the plurality of electrode leads are extended, are identical to one another.

According to this structure, the gyro vibration piece can be supported more evenly with respect to the center of gravity thereof.

According to another aspect of the invention, an electronic device is equipped with the above-described piezoelectric vibration gyro sensor.

According to this structure, inclusion of the gyro sensor having an excellent detection sensitivity makes it possible to provide an electronic device that is excellent, for example, in position control and vibration control compensation functions. Moreover, the gyro vibration piece of the gyro sensor having a plane structure contributes to slimming down and miniaturization of the electronic device.

### BRIEF DESCRIPTION OF THE DRAWINGS

The invention will now be described with reference to the accompanying drawings, wherein like numbers reference like elements.

FIG. 1A is a front view illustrating a gyro sensor according to one embodiment of the invention and a supporting structure thereof. FIG. 1B is a cross-sectional view taken along line A-A of FIG. 1A.

FIG. 2 is a schematic diagram illustrating drive vibration of a gyro vibration piece.

FIG. 3 is a schematic diagram illustrating detection vibration of the gyro vibration piece.

FIG. 4 is a schematic perspective view illustrating an arrangement of bump electrodes of the gyro vibration piece according to the embodiment of the invention and extension directions of electrode leads.

FIG. 5A is a plan view illustrating an arrangement of the electrode leads of a supporting substrate according to one embodiment of the invention. FIG. 5B is a plan view illustrating an exemplary variant of the supporting substrate.

FIG. 6 is a plan view illustrating an exemplary variant of FIG. 4.

FIG. 7 is a perspective view illustrating a schematic structure of a digital still camera as an exemplary electronic device of the invention.

FIG. 8 is a perspective view illustrating a schematic structure of a camera-equipped mobile phone as another exemplary electronic device of the invention.

### DESCRIPTION OF EXEMPLARY EMBODIMENTS

Embodiments of the invention will now be described.

### First Embodiment

Hereinafter, a structure for supporting a gyro vibration piece and a gyro sensor according to one embodiment of the invention will be described with reference to the accompanying drawings.

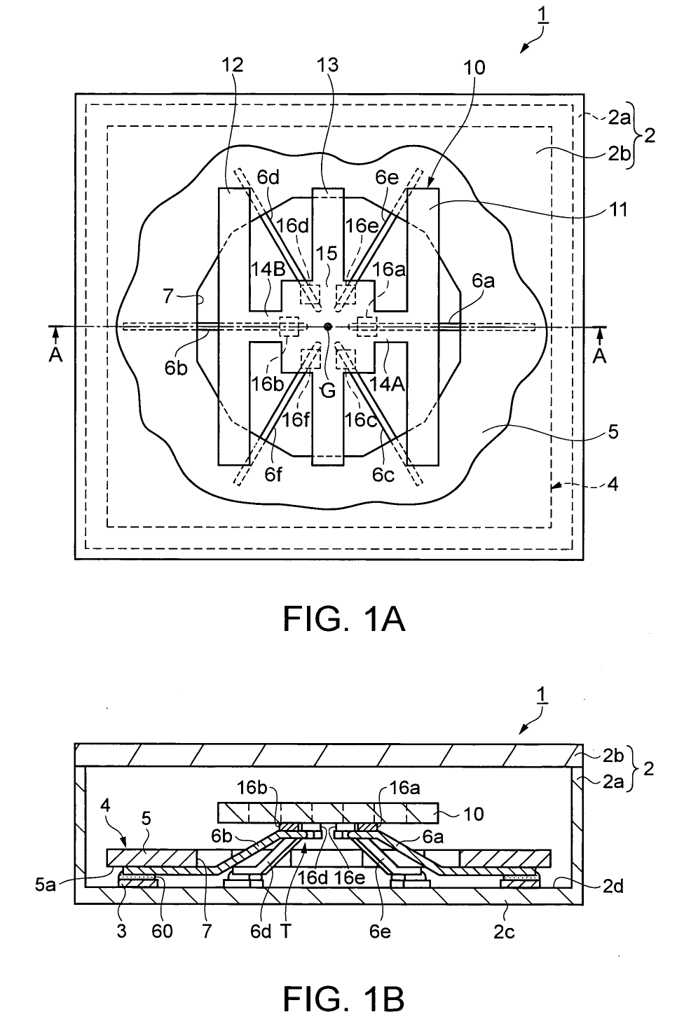

FIG. 1A is a front view illustrating a gyro sensor and a supporting structure thereof, and FIG. 1B is a cross-sectional view of the gyro sensor taken along line A-A of FIG. 1A. Note that in FIG. 1A, a package lid that covers the gyro sensor is partly cut away for illustration thereof.

Gyro Sensor

First, an overall structure of a gyro sensor 1 will now be described.

The gyro sensor 1 includes: a gyro vibration piece 10 as a piezoelectric vibration gyro vibrator made of quartz; a plurality of (six in this embodiment) electrode leads 6a to 6f that serve to support and are electrically connected to the gyro vibration piece 10; a supporting substrate 4 having a base 5 that serves to support one end of each of the electrode leads 6a to 6f; a package body 2a, which is a case of a package 2 that houses the supporting substrate 4 and the gyro vibration piece 10 supported thereon; and a package lid 2b as a top board that closes an upper opening of the package body 2a.

The supporting substrate 4 is secured, via an electrically conductive adhesive 60 such as a silver paste, to a substantially central portion of a recessed bottom surface 2d of the package body 2a formed of ceramic or the like such that a pattern surface 5a of the supporting substrate 4 faces downward. The supporting substrate 4 has the base 5 formed of polyimide resin or the like, and a regular dodecagonal opening 7 is formed at a central portion of the base 5. The plurality of electrode leads (inner leads) 6a to 6f provided on the supporting substrate 4 extend through substantially a middle of each side of every other pair (i.e., three pairs in total) of opposing sides of the opening 7 so as to be perpendicular to the respective sides. One end (i.e., a base end) of each of the electrode leads 6a to 6f is held on the pattern surface 5a, i.e., a back side of the base 5, while the other end (i.e., a top end) thereof protrudes and extends toward a center of gravity G of the gyro vibration piece 10, which will be described later. The electrically conductive adhesives 60 used to secure the supporting substrate 4 to the recessed bottom surface 2d of the package body 2a have first been applied to a part of each of the electrode leads 6a to 6f as well as connection terminals 3 provided on the recessed bottom surface 2d of the package body 2a and then hardened to secure the supporting substrate 4. Since the connection terminals 3 each have continuity with an external connection portion (not shown) provided outside through a bottom plate portion 2c of the package body 2a, each of the electrode leads 6a to 6f has continuity with the corresponding external connection portion.

In addition, each of the electrode leads 6a to 6f is at one point bent obliquely upward toward the center of the opening 7 and then at another point on the top end side bent so as to extend horizontally again.

Note that the present embodiment has adopted a structure in which the supporting substrate 4 is secured to the recessed bottom surface 2d of the package body 2a such that the pattern surface 5a faces downward. However, the invention is not limited to this. A structure may be adopted in which the pattern surface 5a faces upward. This alternative structure can be achieved, for example, by notching the base 5 to obtain recesses or openings at positions at which the electrode leads 6a to 6f are connected to the corresponding connection terminals 3 and applying the electrically conductive adhesive 60 to both the connection terminals 3 and a part of each of the electrode leads 6a to 6f to achieve continuity therebetween.

Upper surfaces of top end portions of the electrode leads 6a to 6f, which extend horizontally as a result of bending, are coupled to, and thus electrically connected to, electrode bumps 16a to 16f as terminal connectors that are made of gold or the like and formed in a substantially central portion of the gyro vibration piece 10. As a result, a lower surface (i.e., a back surface) of the gyro vibration piece 10 is supported such that the entire lower surface except the portions at which the electrode bumps 16a to 16f are formed is not in contact with the electrode leads 6a to 6f. In addition, the lower surface thereof is supported by the electrode leads 6a to 6f, i.e., by the top end portions of the electrode leads 6a to 6f that are positioned away from the base 5 as a result of bending, while a space T is formed to prevent the lower surface thereof from having contact with the base 5.

Gyro Vibration Piece

Next, the gyro vibration piece 10 will now be described in detail with reference to the drawings.

First, a structure of the gyro vibration piece 10 will now be described.

As illustrated in FIG. 1A, in order to operate in three modes hitherto known as a drive mode, a detection mode, and a spurious mode, the gyro vibration piece 10 used in the gyro sensor 1 includes: a first drive arm 11 and a second drive arm 12 that serve for the drive mode; a detection arm 13 that serves for the detection mode; connection arms 14A and 14B; and a supporting plate portion 15.

The pair of connection arms 14A and 14B extend straight in mutually opposite directions from a middle point of opposing sides (upper and lower edges, in FIG. 1A) of the supporting plate portion 15 having a square plate-like shape such that axes of both connection arms coincide with each other. One end of the connection arm 14A is connected to a middle position of the first drive arm 11 with respect to an extension direction thereof, while one end of the connection arm 14B is connected to a middle position of the second drive arm 12 with respect to an extension direction thereof. The detection arm 13 extends straight from a middle point of the other opposing sides (right and left edges, in FIG. 1A) of the supporting plate portion 15 such that an axis thereof passes through a center of gravity G of the supporting plate portion 15 (i.e., of the gyro vibration piece 10 as well). The supporting plate portion 15 is a plate-like portion having a predetermined area including a point of connection between the connection arms 14A and 14B and the detection arm 13, and serves as a supporting portion (a base) at which the gyro vibration piece 10 is supported by the supporting substrate 4.

Operation of Gyro Vibration Piece

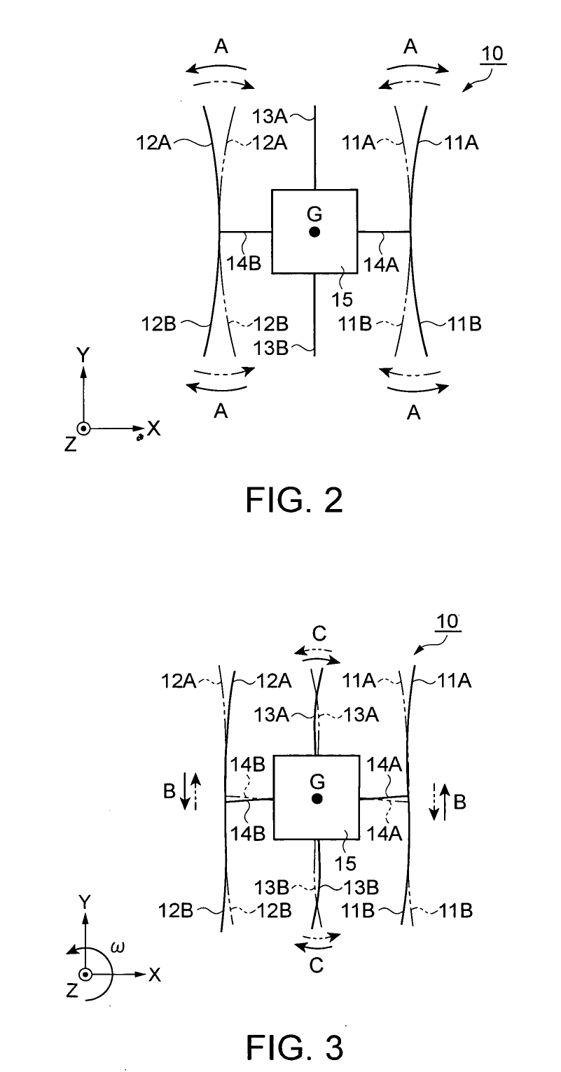

Next, operating principles of the gyro vibration piece 10 will now be described with reference to the drawings. FIG. 2 is a schematic diagram illustrating a drive vibration operation of the gyro vibration piece 10, and FIG. 3 is a schematic diagram illustrating a detection vibration operation of the gyro vibration piece 10. Note that in FIGS. 2 and 3, in order to facilitate understanding of vibrating manners, each arm is represented simply by a line and divided into two parts, as denoted by characters A and B added to the reference character of each arm, based on a base point of motion or the like. Also note that like elements are denoted by like reference characters as in FIGS. 1A and 1B, and explanation thereof is omitted.

First, drive vibration will now be described. In FIG. 2, the drive vibration is bending vibration in which the first and second drive arms 11A and 11B, and 12A and 12B each vibrate in directions indicated by arrows A, and a vibration state as represented by solid lines and another vibration state as represented by chain double-dashed lines alternate at a predetermined frequency. At this time, since the first drive arm 11A and 11B and the second drive arm 12A and 12B vibrate in a symmetrical manner with respect to Y axis that passes through the center of gravity G, the connection arms 14A and 14B and the detection arm 13A and 13B vibrate little.

Next, detection vibration will now be described. In detection vibration as illustrated in FIG. 3, a vibration state as represented by solid lines and another vibration state as represented by chain double-dashed lines alternate at the same frequency as that of the above-described drive vibration. The detection vibration is caused by the Coriolis force acting upon the first drive arm 11A and 11B and the second drive arm 12A and 12B in directions as indicated by arrows B upon application of a rotational angular velocity w about Z axis to the gyro vibration piece 10 when the gyro vibration piece 10 is performing the drive vibration as illustrated in FIG. 2.

Thus, the first and second drive arms 11A and 11B, and 12A and 12B vibrate in such a manner as indicated by arrows B. The vibration as indicated by arrows B is vibration in circumferential directions with respect to the center of gravity G. In addition, at the same time, in response to the vibration as indicated by arrows B, the detection arm 13A and 13B vibrates in such a manner as indicated by arrows C, i.e., in circumferential directions opposite to those indicated by arrows B. A magnitude of the Coriolis force is obtained by detecting an electric signal generated by the detection vibration of the detection arm 13A and 13B, and thereby a magnitude of the rotational angular velocity ω applied to a body containing the gyro sensor 1 including the gyro vibration piece 10 is recognized.

Arrangement of Electrodes on Gyro Vibration Piece and Extension Directions of Electrode Leads.

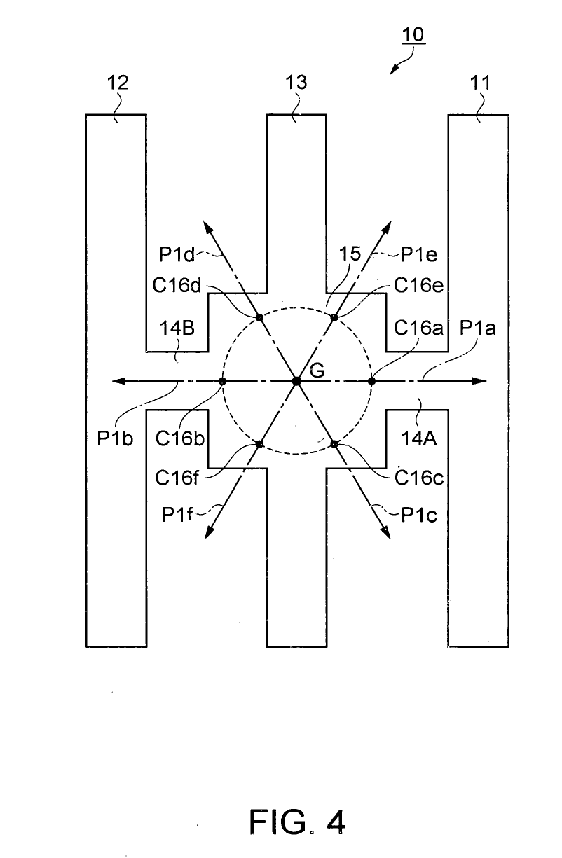

An arrangement of the electrode bumps 16a to 16f on the supporting plate portion 15 of the gyro vibration piece 10 and extension directions of the electrode leads 6a to 6f, one end of each of which is connected to a corresponding one of the electrode bumps 16a to 16f, will now be described in detail below with reference to the drawings. FIG. 4 is a schematic plan view illustrating the arrangement of the electrode bumps on the gyro vibration piece 10 and the extension directions of the electrode leads. Note that in FIG. 4, for ease of explanation of the arrangement of the electrode bumps 16a to 16f on the gyro vibration piece 10, central points C16a to C16f of the electrode bumps are shown. Also note that, for ease of explanation of the extension directions of the electrode leads 6a to 6f, central lines of the electrode leads 6a to 6f in the longitudinal direction are shown as “lead extension direction lines” P1a to P1f.

The central point C16a of the electrode bump 16a is provided at a predetermined distance from the center of gravity G of the gyro vibration piece 10 and in the direction parallel to the extension direction of the connection arm 14A therefrom. The central point C16b of the electrode bump 16b is provided at the aforementioned predetermined distance from the center of gravity G and in the direction parallel to the extension direction of the connection arm 14B therefrom. That is, the central points C16a and C16b of the electrode bumps 16a and 16b are provided so as to be symmetrical with respect to the center of gravity G on a central axis line (i.e., the lead extension direction lines P1a and P1b) that passes through base points of bending vibration (which occurs in the circumferential directions) of each of the first and second drive arms 11 and 12 and the detection arm 13. Meanwhile, the central point C16c of the electrode bump 16c is provided at a position where the central point C16a of the electrode bump 16a would be located if rotated 60 degrees around the center of gravity G in a clockwise direction. The central point C16d of the electrode bump 16d is provided at a position where the central point C16b of the electrode bump 16b would be located if rotated 60 degrees around the center of gravity G in the clockwise direction. As a result, the central points C16c and C16d of the electrode bumps 16c and 16d are provided so as to be symmetrical with respect to the center of gravity G on a straight line (i.e., the lead extension direction lines P1c and P1d) that passes through the center of gravity G. Further, the central point C16e of the electrode bump 16e is provided at a position where the central point C16a of the electrode bump 16a would be located if rotated 60 degrees around the center of gravity G in a counterclockwise direction. The central point C16f of the electrode bump 16f is provided at a position where the central point C16b of the electrode bump 16b would be located if rotated 60 degrees around the center of gravity G in the counterclockwise direction. As a result, the central points C16e and C16f of the electrode bumps 16e and 16f are provided so as to be symmetrical with respect to the center of gravity G on a straight line (i.e., the lead extension direction lines P1e and P1f) that passes through the center of gravity G.

Accordingly, the electrode bumps 16a to 16f, whose central points are, respectively, the above-described central points C16a to C16f, are disposed at the same distance from the center of gravity G of the gyro vibration piece 10 and at the same interval on a circle whose center is the center of gravity G. That is, the electrode bumps 16a, 16b, 16c, 16d, 16e, and 16f are arranged on the circle (as indicated by a dotted line in the figure) whose center is the center of gravity G so as to be symmetrical with respect to the center of gravity G.

Each of the electrode leads 6a to 6f has one end thereof connected to a corresponding one of the electrode bumps 16a to 16f. The other end of each of the electrode leads 6a to 6f is extended along a direction of a corresponding one of the lead extension direction lines P1a, P1b, P1c, P1d, P1e, and P1f, which are extensions of lines that join the center of gravity G of the gyro vibration piece 10 and the central points C16a to C16f of the electrode bumps 16a to 16f, respectively, and held by the base 5 of the supporting substrate 4. At this time, angles the are formed at the center of gravity G by each pair of neighboring lead extension direction lines P1a and P1c, P1a and P1e, P1b and P1f, P1b and P1d, P1c and P1f, and P1d and P1e are all equal, i.e., 60 degrees.

Supporting Substrate and Mounting Method

Next, the supporting substrate 4 will now be described in detail with reference to the drawings.

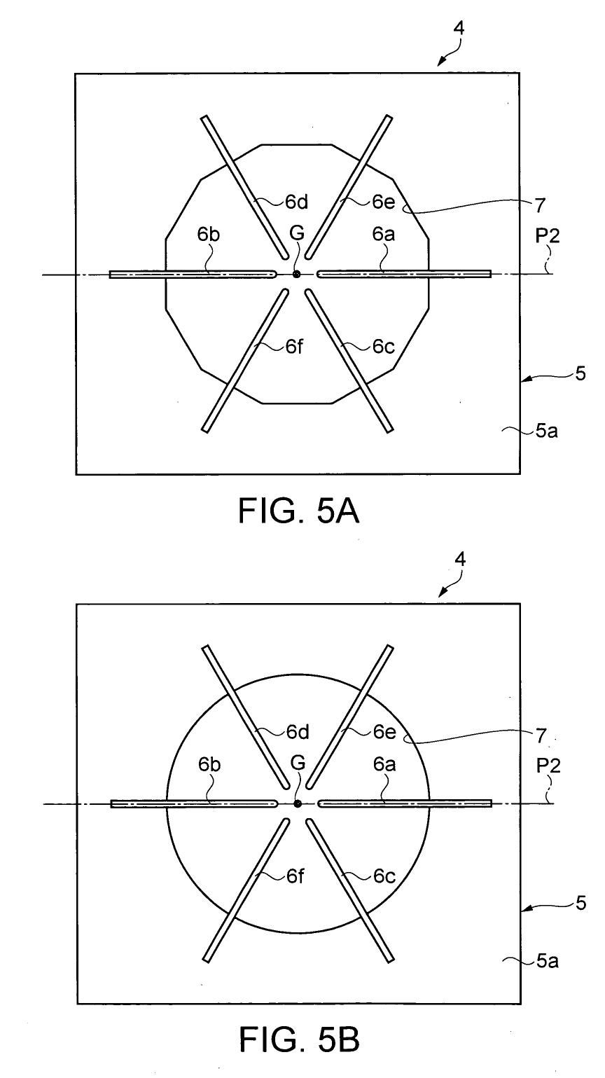

FIG. 5A is a plan view for explaining the arrangement of the electrode leads on the supporting substrate according to the present embodiment. FIG. 5B is a plan view illustrating an exemplary variant of the supporting substrate 4.

The supporting substrate 4 is a substrate for Tape Automated Bonding (TAB) mounting, which is conventionally known. The supporting substrate 4 has an adhesive layer (now shown) on an upper surface thereof. After the regular dodecagonal opening 7 is formed by press working in the base made of a flexible resin such as polyimide, a metal leaf for electrode use, such as a copper leaf, is pasted thereon via the adhesive layer. Thereafter, an electrode pattern, such as the electrode leads 6a to 6f, is formed thereon by photolithography. Note that since the central point of the opening 7 will correspond to the center of gravity G when the gyro vibration piece 10 is mounted thereon, the central point of the opening 7 is shown in the figure as the center of gravity G. Accordingly, the electrode leads 6a to 6f are formed in a so-called overhang structure, i.e., held on the base 5 via the adhesive layer while being extended toward the center of gravity G of the opening 7. Gold plating is applied to surfaces of the plurality of electrode leads 6a to 6f, and thus a metal layer for connection use is formed thereon. Note that, for the metal leaf for electrode use for forming the electrode leads 6a to 6f, materials other than copper may be used instead as long as they are metals capable of pattern forming by etching. Also note that the shape of the opening 7 may be a circular shape with the center of gravity G for its center, as illustrated in FIG. 5B.

The plurality of electrode leads 6a to 6f overhanging the opening 7 are formed to have the same width and the same length and extended toward the center of gravity G of the opening 7 through substantially a middle of each side of every other pair (i.e., three pairs in total) of opposing sides (which run in parallel) of the regular dodecagonal opening 7 so as to be perpendicular to the respective sides. That is, the electrode leads 6a to 6f form three pairs that are symmetrical with respect to the center of gravity G of the opening 7 as shown in the figure, and they are also symmetrical with respect to a central line P2 that divides the opening 7 into two parts at two sides thereof where the pair of electrode leads 6a and 6b are formed, as shown in the figure. In the present embodiment, the electrode leads 6a and 6b, 6c and 6d, and 6d end 6f form three pairs that are each symmetrical with respect to the center of gravity G while a predetermined interspace is formed between opposing top ends thereof over the opening 7. The top end of each of the electrode leads 6a to 6f is located at a position suitable for a corresponding one of the electrode bumps 16a to 16f on the gyro vibration piece 10.

The electrode bumps 16a to 16f are connected to the respective electrode leads 6a to 6f of the supporting substrate 4 by so-called gang bonding, where connection is collectively established by pressing a thermocompression tool at a predetermined temperature under a predetermined pressure. By the action of heat and pressure at this time, the gold that forms the electrode bumps 16a to 16f and the gold that forms at least the surface layer of the corresponding electrode leads 6a to 6f are connected to each other with a predetermined mechanical strength.

In addition, at the time of gang bonding, the height of the gyro vibration piece 10 and the height of the supporting substrate 4 are so adjusted that bent shapes of the electrode leads 6a to 6f in a thickness direction are formed under control. Accordingly, the space T can be formed so that the lower surface of the gyro vibration piece 10 is not in contact with the supporting substrate 4. In the present embodiment, the space T is formed so as to secure a clearance of 50 μm or greater between the supporting substrate 4 and the gyro vibration piece 10 (see FIG. 1B).

Note that in the present embodiment, gold plating is applied to the surfaces of the electrode leads 6a to 6f, and the electrode leads 6a to 6f are connected by gang bonding to the electrode bumps 16a to 16f, made of gold, of the gyro vibration piece 10. However, the invention is not limited to this. For example, a eutectic phenomenon of gold and tin may be used for connection. As long as electrical connection is achieved with a predetermined connection strength, other metallic materials such as tin, nickel, or solder alloy may be used as a plating metal applied to the electrode leads 6a to 6f and as the metallic materials for the electrode bumps 16a to 16f to achieve the connection. Also note that, instead of metallic connection by gang bonding, other connecting methods may be used, e.g., a method employing an electrically conductive adhesive.

Also note that in the present embodiment, the supporting substrate 4 singly supports the gyro vibration piece 10 and is secured to the recessed bottom surface 2d of the package body 2a. However, the invention is not limited to this. A reinforcing plate such as a metal plate may be adhered onto a surface of the supporting substrate 4 opposite to the pattern surface 5a in order to reinforce the base 5.

In a state where the gyro vibration piece 10 is mounted on the supporting substrate 4, in the opening 7 of the supporting substrate 4, the electrode leads 6a to 6f each having the same thickness are extended from the above-described lead extension direction lines P1a to P1f, respectively, so as to protrude by the same distance, and one end of each of the electrode leads 6a to 6f is connected to a corresponding one of the electrode bumps 16a to 16f, which are arranged so as to be symmetrical with respect to the center of gravity G of the gyro vibration piece 10. That is, each of the electrode leads 6a to 6f has the same resonance frequency at least at a part thereof that supports the gyro vibration piece 10 (i.e., a part thereof that overhangs the opening 7). Accordingly, the gyro vibration piece 10 is supported by the electrode leads 6a to 6f evenly with respect to the center of gravity G, which makes it possible to maintain a well-balanced stable posture of the gyro vibration piece 10 while at the same time preventing a local restriction from occurring in connection with vibration characteristics of the gyro vibration piece 10.

Next, the supporting structure for the gyro vibration piece 10, which is achieved by the supporting substrate 4 of the gyro sensor 1 having the above-described structure, will now be described in terms of its action.

If an electronic device or the like that contains the gyro sensor 1, which is to be subjected to compensation, experiences vibration, rotation, or the like, the gyro vibration piece 10 included in the gyro sensor 1 recognizes it in terms of the magnitude of the rotational angular velocity of the vibration, rotation, or the like. At this time, the gyro vibration piece 10 is supported in a well-balanced and flexible manner by the electrode leads 6a to 6f of the supporting substrate 4, which support the gyro vibration piece 10 evenly with respect to the center of gravity G thereof. For example, if a vibration or a shock at the time of falling is applied to the gyro sensor 1, the vibration or shock experienced by the package 2 propagates to the gyro vibration piece 10 inside the package 2 through the electrode leads 6a to 6f, and, in addition, a vibration or a shock is applied thereto due to inertia. The vibration or shock experienced by the gyro vibration piece 10 is attenuated by spring characteristics of the electrode leads 6a to 6f, and meanwhile, the vibration or shock experienced by the package 2 is also attenuated by the spring characteristics of the electrode leads 6a to 6f so that the vibration or shock becomes less likely to propagate up to the gyro vibration piece 10. Therefore, a vibration characteristic of the gyro vibration piece 10 is not easily affected by the supporting structure.

In addition, the electrode leads 6a to 6f each have the same resonance frequency and support the gyro vibration piece 10 evenly with respect to the center of gravity G thereof. Therefore, when a shock is applied to the gyro sensor 1, for example, a displacement load on the gyro vibration piece 10 inside the package 2 can be attenuated more evenly.

Moreover, a spring constant of the electrode leads 6a to 6f is so adjusted that a natural vibration frequency of the gyro sensor 1 has such a value as to make it less likely that resonance whose vibration source is the gyro vibration piece 10 occur. Thus, when the gyro sensor 1 is used, resonance is less likely to occur, and reduction in detection precision owing to resonance is controlled. Therefore, a high detection precision is achieved when detecting the rotational angular velocity using the gyro sensor 1.

Next, effects of the above-described embodiment will now be described below.

First, in the above-described embodiment, the plurality of electrode bumps 16a to 16f on the gyro vibration piece 10 are disposed at the same interval on a circle whose center is the center of gravity G of the gyro vibration piece 10 so as to be symmetrical with respect to the center of gravity G. Then, one end of each of the electrode leads 6a to 6f is connected to a corresponding one of the electrode bumps 16a to 16f, and the electrode leads 6a to 6f are extended by the same length in the directions of extension lines that pass from the center of gravity G through, respectively, the central points C16a to C16f of the electrode bumps, so that the gyro vibration piece 10 is supported thereby.

As a result, the gyro vibration piece 10 is supported in a well-balanced and flexible manner by the electrode leads 6a to 6f of the supporting substrate 4, which support the gyro vibration piece 10 evenly with respect to the center of gravity G thereof. Therefore, when a vibration or a shock at the time of falling is applied to the gyro sensor 1, for example, the vibration or shock experienced by the gyro vibration piece 10 is evenly attenuated by the electrode leads 6a to 6f. This serves to prevent reduction in vibration detection sensitivity, such as reduction in detection output due to displacement of a vibration detection axis. Such displacement might be caused by a stress of a shock causing a part of the electrode leads 6a to 6f to undergo plastic deformation, resulting in tilting of the gyro vibration piece 10. Moreover, since it is possible to reduce uneven displacement of the gyro vibration piece 10 at the time of application of a shock, it is possible to prevent a trouble of, e.g., breakage caused by the gyro vibration piece 10 striking against an inner wall of the package 2.

Second, in the above-described embodiment, from among the electrode bumps 16a to 16f disposed on the gyro vibration piece 10 so as to be symmetrical with respect to the center of gravity G thereof, one pair of electrode bumps 16a and 16b are disposed on the central axis line that passes through the base points of bending vibration (which occurs in the circumferential directions) of each of the first and second drive arms 11 and 12 and the detection arm 13. In addition, the electrode bumps 16c and 16d are disposed at positions where the electrode bumps 16a and 16b would be located if rotated 60 degrees around the center of gravity G in the clockwise direction with respect to the central axis line, which is the base points of the bending vibration, whereas the electrode bumps 16e and 16f are disposed at positions where the electrode bumps 16a and 16b would be located if rotated 60 degrees around the center of gravity G in the counterclockwise direction.

As a result, the gyro vibration piece 10 is capable of being supported evenly also with respect to the vibration direction of each of the first and second drive arms 11 and 12 and the detection arm 13, and thus, the supporting structure is less likely to act preventively against the vibration characteristic of the gyro vibration piece 10. Therefore, the detection precision of the gyro sensor 1 can be increased.

Third, in the above-described embodiment, each of the electrode leads 6a to 6f is arranged to have the same resonance frequency at a portion supporting the gyro vibration piece 10. As a result, the supporting structure formed of the electrode bumps 16a to 16f and the electrode leads 6a to 6f arranged evenly with respect to the center of gravity G of the gyro vibration piece 10 achieves a greater evenness, making it possible to support the gyro vibration piece 10 in a more well-balanced manner.

Fourth, in the above-described embodiment, Au plating is applied to the surfaces of the plurality of electrode leads 6a to 6f, and gold bumps are used as the electrode bumps 16a to 16f, which are connection portions of the gyro vibration piece 10, and then they are connected to each other.

As a result, it is possible to make the electrode leads 6a to 6f less inclined to experience surface deterioration such as corrosion, and make migration or the like at the connection portions less likely to occur. Therefore, it is possible to provide the gyro sensor 1 having high reliability.

Fifth, in the present embodiment, the TAB mounting method is employed in which top end portions (positioned near the center of gravity G of the opening 7) of the electrode leads 6a to 6f of the supporting substrate 4 are connected by gang bonding to the respective electrode bumps 16a to 16f provided on the lower surface of the supporting plate portion 15 positioned at the substantially central portion of the gyro vibration piece 10, while the supporting substrate 4 (TAB substrate) is used as a substrate for supporting the gyro vibration piece 10.

Therefore, the so-called TAB mounting method can be adopted in which the gyro vibration pieces 10 are coupled to the supporting substrates sequentially in a reel-to-reel manner by using a hoop-shaped supporting substrate reel on which the supporting substrates 4 for the gyro vibration pieces 10 are formed at an equal interval. Therefore, it is possible to produce the gyro sensors 1 efficiently with excellent productivity. Moreover, by properly adjusting the height of the gyro vibration piece 10 and the height of the supporting substrate 4 at the time of gang bonding, the shapes of the electrode leads 6a to 6f bent toward the gyro vibration piece 10 can be formed under control. Thus, it is possible to secure an optimum clearance between the supporting substrate 4 and the gyro vibration piece 10 so that if a vibration or a shock such as falling is applied to the gyro sensor 1, the lower surface of the gyro vibration piece 10 will never touch the supporting substrate 4 and the gyro vibration piece 10 will never touch the package lid 2b. Therefore, it is possible to provide the supporting structure of the gyro sensor 1 with an excellent shock resistance.

### Second Embodiment

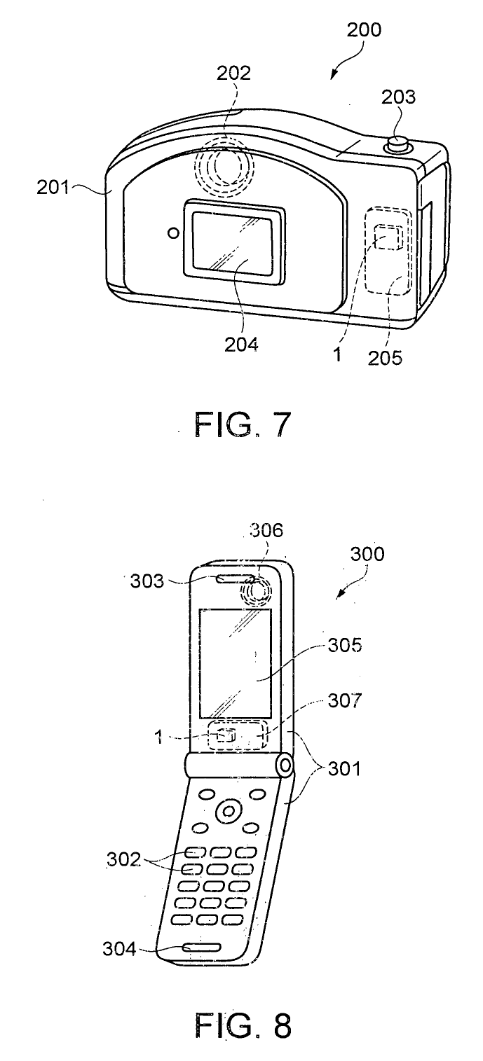

In the above-described first embodiment, the supporting structure for the gyro vibration piece 10 and the gyro sensor 1 achieved thereby have been described. The invention is not limited to them. It is possible to provide electronic devices containing the gyro sensor 1, such as a digital still camera 200 as illustrated in FIG. 7, a camera-equipped mobile phone 300 as illustrated in FIG. 8, and the like.

FIG. 7 is a schematic perspective view illustrating a structure of the digital still camera. FIG. 8 is a schematic perspective view illustrating a structure of the camera-equipped mobile phone.

In FIG. 7, the digital still camera 200 has a display panel 204, such as a liquid crystal display, provided on a rear side of a main body case 201. In addition, a photodetector 202 including an optical lens, a charge coupled device (CCD), etc., is provided on an observation side (i.e., on a hidden side, in the figure) of the main body case 201 of the digital still camera 200, and a shutter button 203 is provided on an upper surface of the main body case 201. While traditional cameras perform film exposure with a light image of a picture subject, the digital still camera 200 subjects a light image of a picture subject to photoelectric conversion using an image pickup device such as the CCD to generate an image pickup signal. The display panel 204 performs a display based on the image pickup signal obtained by the CCD, and functions as a finder that displays the picture subject.

If a picture taker checks an image of the picture subject on the display panel 204 and presses the shutter button 203, a shutter (not shown) opens and an image pickup signal obtained by the CCD at the time is transferred to a memory (not shown) mounted on a circuit substrate 205 provided inside the main body case 201 and stored therein as image data. At this time, an orientation change or tilting caused, for example, by unintentional hand movement while the shutter is open is detected as an angular velocity by the gyro sensor 1 mounted on the circuit substrate 205, and based on the detection, hand movement compensation is performed to compensate for displacement of an image formation position of the picture subject.

In FIG. 8, the camera-equipped mobile phone 300 includes a main body case 301, and the main body case 301 has provided thereon a plurality of operation buttons 302, a reception port 303, a transmission port 304, and a display panel 305, such as a liquid crystal display, along with a camera unit 306, which is provided on a hidden side of the main body case 301 in the figure. The camera-equipped mobile phone 300 has a fundamental telephone function and, besides, can be shifted to a camera function mode by operating one of the plurality of operation buttons. In the case where the camera function mode is selected, one of the plurality of operation buttons has a shutter button function, and the display panel 305 functions as a finder that displays a picture subject. An image signal of the picture subject inputted via the camera unit 306 in response to a similar operation by the picture taker to that in the case of the above-described digital still camera 200 is subjected to the hand movement compensation by the gyro sensor 1 mounted on a circuit substrate 307 provided inside the main body case 301, and stored as image data in a memory (not shown) on the circuit substrate 307.

According to the above-described structures, with respect to an image of a picture subject photographed using the digital still camera 200 or the camera-equipped mobile phone 300, image blurring, which might occur as a result of unintentional hand movement or the like while the shutter is open at the time of photographing, can be controlled by the gyro sensor 1 contained therein, and thus, image quality can be improved. Moreover, the gyro sensor 1, which includes the supporting structure according to the above-described first embodiment and the gyro vibration piece 10 having a plane structure, has a relative advantage for mounting in a small-sized and slim type electronic device, such as the camera-equipped mobile phone 300 in particular. Therefore, the gyro sensor 1 makes it possible to provide an excellent electronic device while contributing to slimming down and miniaturization of the electronic device.

The invention is not limited to the above-described embodiments, but exemplary variants as described below are also practicable.

First, in the above-described first embodiment, the electrode bumps 16a to 16f arranged on a circle whose center is the center of gravity G of the gyro vibration piece 10 so as to be each positioned at the same distance from the center of gravity G are arranged to be disposed at the same interval on the circle whose center is the center of gravity G. However, the invention is not limited to this. As long as the electrode bumps 16a to 16f are disposed on the circle whose center is the center of gravity G so as to be symmetrical with respect to the center of gravity G, a supporting structure that produces substantially the same effects can be achieved without disposing the electrode bumps 16a to 16f at the same interval on the circle.

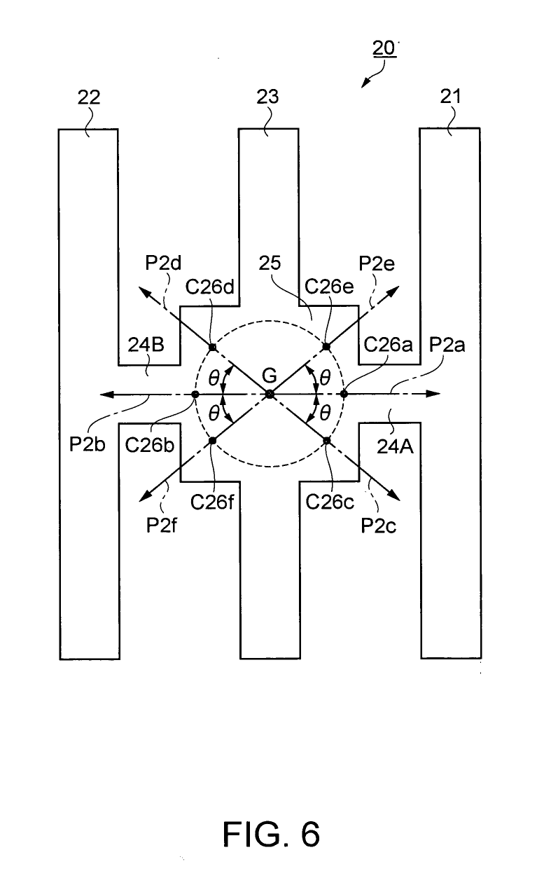

As illustrated in FIG. 6, a central point C26b of an electrode bump 26b of a gyro vibration piece 20 is provided at a position in a direction parallel to an extension direction of a connection arm 24B from a center of gravity G so as to be the same distance away from the center of gravity G as a central point C26a of an electrode bump 26a. In addition, a central point C26c of an electrode bump 26c is provided at a position where the central point C26a of the electrode bump 26a would be located if rotated an arbitrary angle θ (less than 60 degrees) around the center of gravity G in a clockwise direction, whereas a central point C26d of an electrode bump 26d is provided at a position where the central point C26b of the electrode bump 26b would be located if rotated the angle θ around the center of gravity G in the clockwise direction. Moreover, a central point C26e of an electrode bump 26e is provided at a position where the central point C26a of the electrode bump 26a would be located if rotated the angle θ around the center of gravity G in a counterclockwise direction, whereas a central point C26f of an electrode bump 26f is provided at a position where the central point C26b of the electrode bump 26b would be located if rotated the angle θ around the center of gravity G in the counterclockwise direction. As a result, the electrode bumps 26a to 26f whose central points are the central points C26a to C26f are disposed so as to be symmetrical with respect to the center of gravity G.

Further, one end of each of the electrode leads 6a to 6f is connected to a corresponding one of the electrode bumps 26a to 26f, while the other end thereof is extended in the direction of a corresponding one of the lead extension direction lines P2a to P2f (shown in the figure) that are extensions of lines that join the center of gravity G of the gyro vibration piece 20 and the respective central points C26a to C26f of the electrode bumps 26a to 26f to be held by the base 5 of the supporting substrate 4. That is, the electrode leads corresponding to the electrode bumps are extended in the directions of the respective lead extension direction lines P2a to P2f so as to be symmetrical with respect to the center of gravity G and at the same time be symmetrical with respect to a virtual central line of the detection arm 23 in a longitudinal direction, and thus supports the gyro vibration piece 20.

Note that in the present exemplary variant, the central points C26a and C26b of the electrode bumps 26a and 26b are set to be reference points for disposing the other electrode bumps, and the central points C26c, C26e, C26d, and C26f of the electrode bumps 26c, 26e, 26d, and 26f are disposed at positions where the central points C26a and C26b would be located if rotated an arbitrary angle θ (less than 60 degrees) around the center of gravity G in the clockwise or counterclockwise direction. However, the invention is not limited to this. As long as the positions of the electrode bumps are symmetrical with respect to the center of gravity G and at the same time be symmetrical with respect to the virtual central line of the detection arm 23 in the longitudinal direction, the angle θ may be greater than 60 degrees.

This structure, although not so well as the structure of the first embodiment does, makes it possible to support the gyro vibration piece 20 evenly with respect to the center of gravity G. Setting such an arrangement of the electrode bumps as a design rule makes it possible to provide a stable and well-balanced supporting structure for a gyro sensor, for example, in the case where a spatial constraint occurs in connection with the arrangement of the electrode bumps as a result of, e.g., forming a functional part on a supporting plate portion 25.

Second, in the above-described first embodiment, manners of determining the arrangement of the electrode bumps and the extension directions of the electrode leads (and the shapes of the leads as well) have been described with respect to the gyro vibration piece having three pairs of (i.e., six) electrode leads. However, the invention is also applicable to a supporting structure for a gyro vibration piece having two pairs, or more than three pairs, of electrode leads. Moreover, in the case where the number of effective electrodes on the gyro vibration piece is an odd number, or in the case where there is a desire to increase the supporting strength of the supporting structure for the gyro vibration piece by using the electrode leads, a dummy electrode bump may be additionally provided in accordance with a rule of the bump arrangement of the above-described first embodiment, and a corresponding dummy electrode lead may be connected to the additional dummy electrode for support.

Third, in the above-described first embodiment, the TAB substrate (the supporting substrate 4) including the insulative base 5 having the opening 7 and the electrode leads 6a to 6f is used as the supporting substrate. However, the invention is not limited to this. As long as the electrode leads that support the gyro vibration piece 10 such that the gyro vibration piece 10 is supported in an elevated state can be formed at the supporting portion, wiring boards other than the TAB substrate may be used instead, for example.

Fourth, in the above-described first embodiment, the electrode leads 6a to 6f each having the same width and length support the gyro vibration piece 10 symmetrically with respect to the center of gravity G. However, the invention is not limited to this. As long as the electrode leads 6a to 6f each have the same resonance frequency in the above-described supporting structure, the widths of the electrode leads 6a to 6f may be different from one another. Moreover, as long as the electrode leads 6a to 6f each have the same resonance frequency in the above-described supporting structure, the shapes of the electrode leads 6a to 6f, viewed in plan, may be different from one another.

Fifth, in the above-described first embodiment, the supporting substrate 4 that supports the gyro vibration piece 10 such that the gyro vibration piece 10 is elevated over the supporting substrate 4 by the formation of the electrode leads 6a to 6f is secured to the recessed bottom surface 2d of the package body 2a. However, the invention is not limited to this. The supporting substrate 4 may be placed securely with the side thereof that supports the gyro vibration piece 10 facing downward, for example, by providing recesses on the recessed bottom surface 2d of the package 2 by a counterboring processing, or by providing a supporting plate at a middle portion of the inside of the package 2.

The entire disclosure of Japanese Patent Application No. 2005-209547, filed Jul. 20, 2005 is expressly incorporated by reference herein.

What is claimed is:

1. A piezoelectric vibration gyro sensor, comprising:
a piezoelectric vibration gyro element including:
a central supporting portion having a plurality of electrode terminals provided thereon;
a detection arm extending from two opposing sides of the central supporting portion and on a symmetry axis that passes through a center of the central supporting portion;
a pair of connection arms extending from other opposing sides of the central supporting portion and in a direction orthogonal to the detection arm; and
a pair of drive arms each extending from a tip of one of the pair of connection arms orthogonally to the respective connection arm and to both sides so that the pair of drive arms are symmetrically arranged with respect to the symmetry axis, wherein the central supporting portion, the detection arm, the pair of connection arms, and the pair of drive arms lie in a common plane; and
a supporting substrate having a plurality of electrode leads one end of each of which is connected to a corresponding one of the plurality of electrode terminals to support the piezoelectric vibration gyro element,
wherein the plurality of electrode terminals are disposed on a virtual circle whose center is a center of gravity of the piezoelectric vibration gyro element so as to be symmetrical with respect to the center of gravity, and
wherein the plurality of electrode leads are each extended on an extension line that passes from the center of gravity through a central point of a corresponding one of the plurality of electrode terminals.

2. The piezoelectric vibration gyro sensor according to claim 1, wherein
the plurality of electrode leads are extended so as to be symmetrical, when viewed in plan, with respect to a virtual line that is orthogonal to the symmetry axis and passes through the center of gravity, or with respect to the symmetry axis.

3. The piezoelectric vibration gyro sensor according to claim 1, wherein
each of the plurality of electrode leads has an identical resonance frequency at least at a portion thereof that serves to support the piezoelectric vibration gyro element.

4. The piezoelectric vibration gyro sensor according to claim 1, wherein
the plurality of electrode leads are extended such that angles formed at the center of gravity by each pair of neighboring extension lines that pass from the center of gravity through the central points of the plurality of electrode terminals, on which the plurality of electrode leads are extended, are identical to one another.

5. An electronic device equipped with the piezoelectric vibration gyro sensor according to claim 1.
